(19) United States
(12) Patent Application Publication
(10) Pub. No.: US 2024/0370917 A1
(43) Pub. Date: Nov. 7, 2024

(54) HOME AUTOMATION AND CONCIERGE SYSTEM AND METHOD FOR A PHYSICAL COMMUNITY OR NEIGHBORHOOD

(71) Applicant: Devcore Group, Gatineau (CA)

(72) Inventor: Jean-Pierre Poulin, Gatineau (CA)

(21) Appl. No.: 18/774,121

(22) Filed: Jul. 16, 2024

Related U.S. Application Data
(63) Continuation-in-part of application No. 17/808,460, filed on Jun. 23, 2022.
Application No. 17/808,460 is a continuation of application No. 17/248,734, filed on Feb. 4, 2021, now abandoned.
Application No. 17/248,734 is a continuation of application No. 15/738,972, filed on Dec. 21, 2017, now abandoned.
(60) Provisional application No. 62/433,690, filed on Dec. 13, 2016.
(60) Provisional application No. 62/413,060, filed on Oct. 26, 2016.

(51) Int. Cl. G06Q 30/0601; G05B 19/042; G06Q 10/0833; G06Q 50/10

(52) U.S. Cl. CPC G06Q 30/0641; G05B 19/042; G06Q 10/0833; G06Q 50/10; G05B 2219/2642

(57) ABSTRACT

The present invention provides a home automation and concierge system and method for a community. A user may access an interface to control home systems and device or use the concierge service to purchase goods and services available for at home delivery. An example method of concierge comprises receiving, by a server computing device comprising an operation module, a request for service(s) and/or product(s) from a user. A ranking of providers capable of completing said request to said user is provided. A selected provider from the ranking of providers to complete the request from said user is received. Completion of the request by said selected provider is enabled. The invention includes a flexible amenity room within the community which can be reserved to complete the requested services. Additionally, a non-resident user can access the system to request a service.

### CROSS-REFERENCE TO RELATED APPLICATIONS

The present application is a Continuation-in-Part of U.S. application Ser. No. 17/808,460, filed Jun. 23, 2022, which is a Continuation of U.S. application Ser. No. 17/248,734, filed Feb. 4, 2021, which is a Continuation of U.S. application Ser. No. 15/738,972, filed Dec. 21, 2017, which is a U.S. National Phase Application of International Application No. PCT/CA2017/051275, filed Oct. 26, 2017, which claims priority to U.S. Provisional Application No. 62/433,690, filed Dec. 13, 2016 and U.S. Provisional Application No. 62/413,060, filed Oct. 26, 2016. The foregoing applications are incorporated by reference herein in their entirety.

### FIELD OF THE INVENTION

The present invention pertains to the field of electronic home management and concierge services, and in particular to a home automation and concierge system and method for a physical community or neighborhood tailored for multi-residential buildings or community settings.

### BACKGROUND

Smart technologies and home-wide wireless networks allow for the control of home systems and devices. The connection of home systems and devices to networks both facilitates centralizing of controls and the accessing of home controls remotely. However, while these technologies have been transformative for individual homes, there's a growing need to adapt and optimize them for multi-residential buildings or community settings.

With increasingly hectic lifestyles the ability to shop at home for goods and services is increasingly popular. Historically, consumers search the internet for a particular product or service and are presented with a vast array of options with respect to vendors and specific products. Consumers must then either comb through the options or refine the search parameters. Reviewing product or service search results from an appropriate vendor can be time intensive. In addition to ensuring that the vendor can meet the consumers' needs in terms of product, service or selection, a consumer wishing to have the product or service at home must identify vendors which deliver or provide in-home services. In-home provision of products and services has generally been limited to fast food style restaurants or the on-line retailers that can use mail or courier services to deliver products. Yet, in a multi-residential building or community setting, the dynamics change. There's an amplified need for systems that can cater to the collective needs of a community, ensuring efficient delivery and service provision tailored for such environments.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a home automation and concierge system and methods for a physical community or neighborhood. In accordance with an aspect of the present invention, there is provided a home automation and concierge system comprising a home management system operatively connected to one or more devices; wherein the home management system is configured to receive input signals from said one or more devices, generate one or more device commands and transmit the one or more device commands to said one or more devices; a home concierge system configured to interact with a cloud-based concierge service and at least one user interface configured to allow a user to operate with the home management system and order from the home concierge system.

In a first aspect, the present disclosure provides a real-time computer implemented method of an in-residence e-commerce service for a physical community or neighborhood. The method comprises: receiving, from a user interface operated by a user, by a server computing device comprising an operation module including a processor, a request for service at a flexible service location within or proximal to the physical community or neighborhood. The request includes a time frame. The method also comprises providing, by the operation module, in accordance with the request, ranked providers for the service located within or proximal to the physical community or neighborhood capable of completing the request. Further, the method includes displaying, on the user interface, for selection by the user, the ranked providers and receiving, by the operation module, from the user interface, a selected ranked provider from the ranked providers to complete the request. Furthermore, the method includes enabling, by the operation module, completion of the request by the selected ranked provider. The completion of the request comprises requesting, by the operation module, a reservation for the service location from the selected ranked provider or the user, granting the reservation based on an availability of the service location; and updating by the operation module and displaying on the user interface an updated availability of the service location. The method also comprises, by a home management system of the service location, interacting with the selected ranked provider and the server computing device and allowing access to the service location of the user for the selected provider, to facilitate completion of the request, wherein the access to the service location is allowed by providing an access code valid for the time frame to the selected ranked provider.

In some implementations of the first aspect, the method further comprises providing a new access code when the access code is invalid after expiry of the time frame. In some implementations of the first aspect, the method further comprises storing information relating to the completed request within a database.

In some implementations of the first aspect, the method further comprises analyzing the information related to the completed request for use in further ranking the selected ranked provider. In some implementations of the first aspect, the database further comprises information regarding past user selections. In some embodiments, the access is overridable.

In some implementations of the first aspect, a geolocate IP address and geospatial data are utilized to provide access to the service location for the selected ranked provider. In some implementations of the first aspect, the server computing device is cloud based.

In some implementations of the first aspect, the method further comprises communicating alternative providers capable of completing the request for service in response to receiving a response indicative of a refusal to the request for service from the selected ranked provider. In some implementations of the first aspect, the service includes a service of delivery of a product.

In a second aspect, the present disclosure provides a system comprising a server computing device and a home management system. The server computing device is in communication with one or more user devices via a network and is configured to interact with the home management system. The server computing device comprises an operation module including a processor and a computer program product storing instructions that when executed by the processor, cause the server computing device to receive, from a user interface on a user device of the one or more user devices, a request for service at a service location within or proximal to the physical community or neighborhood. The request includes a time frame. The instructions also cause the server to provide, via the operation module, ranked providers for the service, the ranked providers located within or proximal to the physical community or neighborhood and capable of completing the request; display, for selection by the user, the ranked provided on the user interface; receive, by the operation module, from the user interface, a selected provider from the ranked providers to complete the request; and cause the home management system to interact with the selected ranked provider and the server computing device to allow access to the service location for the selected provider, to facilitate completion of the request, the access being based on an access code valid for the time frame provided to the selected ranked provider. The instructions further cause the server computing device to request, by the operation module, a reservation for the service location from the selected ranked provider or the user; grant the reservation based on an availability of the service location; and update by the operation module and display on the user interface an updated availability of the service location.

In some implementations of the second aspect, a new access code is provided when the access code is invalid after expiry of the time frame. In some implementations of the second aspect, the instructions further cause the server computing device to store information relating to the completed request within a database. In some implementations of the second aspect, the instructions further cause the server computing device to analyze the information related to the completed request for use in further ranking the selected ranked provider. In some implementations of the second aspect, the database further comprises information regarding past user selections.

In some implementations of the second aspect, the access is overridable. In some implementations of the second aspect, a geolocate IP address and geospatial data are utilized to provide access to the service location for the selected ranked provider. In some implementations of the second aspect, the server computing device is cloud based. In some implementations of the second aspect, the instructions further cause the server computing device to communicate alternative providers capable of completing the request for service in response to receiving a response indicative of a refusal to the request for service from the selected ranked provider. In some implementations of the second aspect, the service includes a service of delivery of a product.

### BRIEF DESCRIPTION OF THE FIGURES

Embodiments of the present invention will be better understood in connection with the following Figure, in which:

FIG. 1 illustrates components of the system.

FIG. 2 illustrates one embodiment of the concierge interface.

FIG. 3 illustrates one embodiment of a restaurant category page for the concierge service.

FIG. 4 illustrates one embodiment of a health category page for the concierge service.

FIG. 5A to 5C illustrates vendor pages in the health category for the concierge service.

FIG. 6 illustrates vendor log in page.

FIG. 7 illustrates an exemplary vendor order page.

FIG. 8 illustrates an exemplary administrator log in page.

FIG. 9 illustrates an exemplary vendor management page.

FIG. 10 illustrates an exemplary page for setting up new accounts.

FIG. 11 illustrates a flow diagram of interactions between parties and elements of the consumer goods and/or services distribution system.

FIG. 12 illustrates a flow diagram of reservation process for a service location, according to an embodiment.

FIG. 13 illustrates a flow diagram of a non-resident user using the system, according to an embodiment.

### DETAILED DESCRIPTION

### Overview

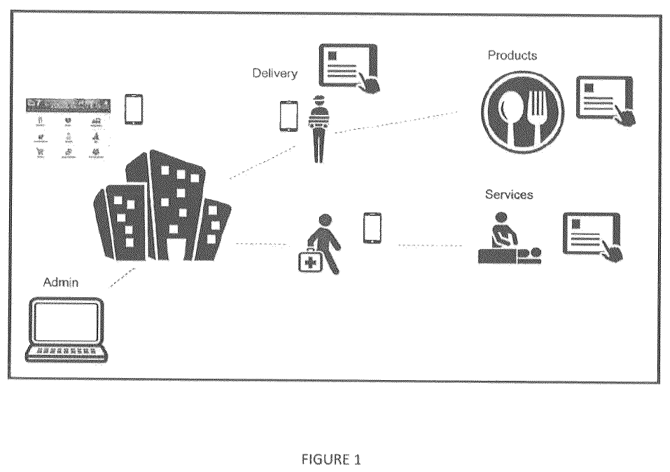

The invention provides systems and methods for home management and concierge services for a physical community or neighborhood, via a server computing device comprising an operation module. As illustrated by FIG. 1, the systems and methods of the invention facilitate the development of a physical community or neighborhood-based commerce by focusing consumer's attention to local retailers and service providers. Optionally, the systems and methods of the invention are configured to facilitate resident to resident (or landlord or condominium board) interactions and commerce such that a resident in a physical community or neighborhood capable of providing a service (for example, a plumber) can offer that service to another member of the community or neighborhood.

In relation to the present disclosure, the terms “community” and “neighborhood” may be used interchangeably. A person having ordinary skill in the art would understand that a community or a neighborhood can involve a pre-defined geographic area, and there may be one or more multi-residential buildings in the community or the neighborhood.

In relation to the present disclosure, the term “user” refers to an end user of consumer goods/products and/or services provided by vendors, and the user can be a resident in a community or neighborhood or a non-resident who uses the platform (e.g., a mobile app or online portal system) allowing the non-resident user to search and obtain goods and services from the vendors. Vendors may be residents of the community or neighborhood. A person having ordinary skill in the art would understand that the term “vendor” refers to a product or service provider, or the like. The vendors also use the platform with respect to various services that the platform provides (e.g., home management system and concierge services, secured entry services via a server computing device or an operation module, etc.). For example, the vendor may track the order history (including current and pending orders) associated with a resident user, a non-resident user. The vendor can also track the order history associated with a building, or a community. Furthermore, the invention allows the vendor to access a secure building or community to fulfill and order (e.g., delivery of products and/or services).

In some embodiments, the systems and methods (via the server computing device) are configured to facilitate peer-to-peer (P2P) commerce and transactions.

The systems and methods of the invention (via the server computing device) are optionally configured to be responsive to the changing needs of the community or neighborhood, for example, changing demographics as populations age.

In some embodiments, the invention (via the server computing device) is configured to provide simplified and intuitive home automation, home security and home concierge service. The system and method are modular and adaptable to the size, the configuration and the type of the community as well as community demographics. Physical communities include multi-unit dwellings, single home communities and mixed dwelling communities and may be defined by geographic boundaries or physical proximity. Multi-unit dwellings include townhomes, apartments including high rise apartments, flats, mix-use buildings, and apartment communities. For mixed dwelling or mixed use communities, the system and method may include residential, business and public modules. Public modules include modules specifically adapted to public spaces including for example community libraries, schools, places of worship, halls and other common areas, etc. In some embodiments, health modules are provided. Communities also include gated communities and those designed for specific demographics such as age-restricted communities including adult communities or senior communities. In such embodiments, modules specifically adapted to the specific demographic are optionally provided.

In some embodiments, mixed use communities may be configured to provide the majority of services used on a day-to-day basis by community members.

The systems and methods may be configured for rental properties, condominiums, co-operatives, leasehold or freehold or other. Fees for use of the service and method may be incorporated into rent or condominium fees or may be payable on a contract basis. In some embodiments, fees for the concierge service are payable by the vendor or the consumer optionally on a per transaction basis or on a subscription basis.

The system and method may be configurable for new builds, retrofits or renovations. In some embodiments, components of the system may be integrated into the dwelling or building structure and/or mounted thereon. The system may also include components remote from the dwellings or buildings including sensors, etc, for example, located in the grounds and/or around the dwellings or buildings of the community.

The system and method may be configured to interact with third party systems including tracking systems, monitoring systems and law enforcement and/or emergency services to provide enhanced or additional services.

In some embodiments, the system and method comprise a cloud-based software platform (e.g., the server computing device) that integrates network-connected systems and devices including sensors to access or operate home automation and home concierge services. The system may be configured to allow for lock out or override of the home automation and/or home concierge service.

Optionally, the system and method is configured to allow for access and use of social media and preferably social media within the community context. Optionally, the system and method may be configured to include a community message board or calendar. In some embodiments, the system and method can be configured to send community wide alerts, including that there happens to be a product or service provider on site for the consumer's convenience, optionally alerts are sent to all users' mobile devices. In some embodiments, the system and method may be configured to include or interact with an emergency broadcast system.

In some embodiments, the home management system and concierge services is configured to interact with smart car systems to facilitate the management of car maintenance. In such embodiments, the concierge service includes car service providers that pick up and drop off cars at home.

The system and method are configured to provide a simplified, user-friendly home management and concierge service by connecting smart home systems with concierge services that are in some embodiments driven by user or consumer preferences. The control of the system and services can be pre-defined, user defined, administrator defined or a combination thereof. In some embodiments, the system and method provides for in-home control and/or access to home systems and/or services. In some embodiments, the system and method provides for remote control and/or access to home systems and/or services. In some embodiments, the system and method provides for both in-home and remote controls. Optionally, the accessibility to specific modules by in-home control, remote control or both can be set by a system administrator.

The system and method for home management and concierge service includes a user interface that allows a user to access home management systems and concierge services. The user interface may include an in-home application and optional mobile application.

In some embodiments, the home management system and concierge services interact with each other to facilitate the delivery of services and/products. For example, the home management system can be programmed to allow access to the home and their home monitoring and security systems for service and product providers to facilitate delivery of services and products. The system may be further configured to facilitate product or service provider tracking.

Optionally, the home management system and concierge services can be configured to send the user reminders regarding recurring appointments. For example, the home management system and concierge can be configured to send the user a reminder regarding the need to schedule a follow up massage appointment.

The system comprises an in-home interface or control panel to provide access to the home management and concierge systems. The in-home interface or control panel may be custom-made or a specifically programmed off-the shelf component. The in-home interface may comprise a tablet, a desktop computer, laptop computer, or the like. In some embodiments, the in-home interface comprises a wall-mounted tablet.

In some embodiments, the in-home interface or control panel is voice controlled.

The interface comprises a home page having a smart menu with a series or set of selectable options and optionally access to the smart menu is protected either by password, biometric scanning or other means known in the art.

In some embodiments, the interface may be configured to lock-out one or more of the services. For example, access to lighting controls may be available to everyone but access to concierge services may be limited to authorized users.

The invention may further comprise a mobile app that allows access to the home management system, the concierge system or both via portable electronic devices including handhelds such as tablets and smart phones, watches and glasses.

In one embodiment, the user of the consumer goods and/or services distribution system and method may be an individual, couple, group, group of individuals, family, roommates, or other entity living within a residential dwelling as would be understood by someone skilled in the art.

In a further embodiment, the user of the consumer goods and/or services distribution system and method may be an individual, couple, group, group of individuals, family, roommates, business, partnership, corporation, or otherwise as would be understood by someone skilled in the art.

In some embodiments, delivery tracking uses radio frequency transponder and remote reader units. In some embodiments, dwellings or buildings are equipped with appropriate equipment.

In some embodiments, the system uses Global Positioning System (GPS) tracking technologies.

In some embodiments, the system uses geolocate Internet Protocol (IP) address and geospatial data to provide access to dwellings or buildings.

In some embodiments, the system and methods use Wi-Fi based positioning systems or iBeacons™.

### Home Management System

The home management system includes home security management and premise management system that includes environmental control management and entertainment management.

Home security management interfaces with home security and safety systems including alarms, security cameras, entry detection systems, fire alarms, sprinkler systems, motion or movement sensors, beacons, location detectors, fall detection and/or health monitoring systems. The system is configured to provide for arming security systems and optionally notifying emergency services in the event of an emergency. In embodiments, a location detector can be a system or a device (e.g., sensors) that is configured to identify the physical locations of individuals or objects within the home or space using technologies such as Global Positioning System (GPS), Radio Frequency Identification (RFID), Wi-Fi, Bluetooth beacons, or other signal triangulation methods, which may be important in customizing security responses and emergency services notification.

In some embodiments, the home security system incorporates facial recognition, voice recognition or other technologies know in the art to allow for identification and/or tracking of individuals and/or objects.

In some embodiments, access to a premise can be provided based on facial recognition or other biometric features.

In some embodiments, the home security management interfaces with community security systems. In apartment or flat style communities, community security systems include public space security cameras, entry detection, motion detectors, and location detectors. The home security management interface, in some embodiments, is configured to allow residents to communicate and/or monitor public spaces and/or allow parties to access the building.

The premise management system provides for the control of home comfort systems including environmental controls such as Heating, Ventilation, and Air Conditioning (HVAC) systems, air quality systems, venting systems, smart window coverings, lighting and illumination controls; home sensors and home entertainment systems including speakers, audio and visual systems, and internet access. The premise management system includes appropriate sensors and control elements as is known in the art.

The system is optionally configured to automatically adjust temperature, humidity and other environmental conditions in response to sensed conditions.

The home management system may optionally be configured to be accessed by a smart device app.

### Concierge Service

The concierge service is configured to simplify consumer choice by preselecting a set of preferred businesses or vendors, optionally the highest consumer rated or ranked businesses or vendors, to offer home services or products. Preferred businesses or vendors will generally be located within or proximal to the community thereby facilitating the development of a close-knit neighborhood. In some embodiments, preferred businesses or vendors will offer both service and products for delivery to a residence and a physical store front. Optionally, preferred business or vendors may offer users of the at-home concierge service preferred customer service or discount.

In some embodiments, residents of the community qualified to provide a specific service or product are included in the preferred businesses or vendors.

In some embodiments, the concierge service is configured to also facilitate peer-to-peer (P2P) commerce and transactions between residents of the community or neighborhood.

The concierge service includes a consumer interface accessible either through the system and method interface or directly by appropriate electronic devices known in the art.

The concierge service is accessible by smart menu with a series of selectable options. In some embodiments, the concierge service shows the top 3 or 4 highest rated or ranked providers of a specific product or service, or the top 3 or 4 ranked pizza restaurants that provide home-delivery. The concierge service can be personalized to show products and services most commonly accessed by the specific consumer up front.

The concierge service can be optimized using the 80-20 Rule such that in some embodiments the products and services offered by each vendor for the concierge service are the 20% of products or services that accounts for 80% of revenue (profit).

In some embodiments, the 80-20 Rule is used to cull vendors that are not maintaining pre-determined standards and replace them with other vendors. In particular, in some embodiments the system and method is configured to either on request or at pre-determined times identify the 20% of vendors which generate 80% of customer complaints for a specific product or service. Once identified, the system administrator can optionally assess the complaints raised against the individual vendors and determine if any further steps are necessary.

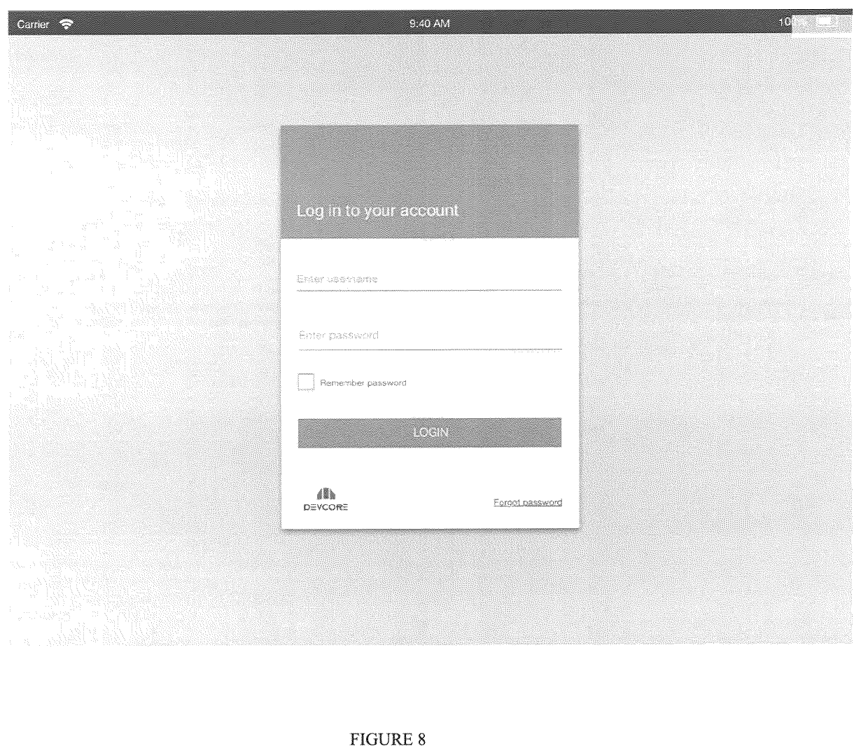

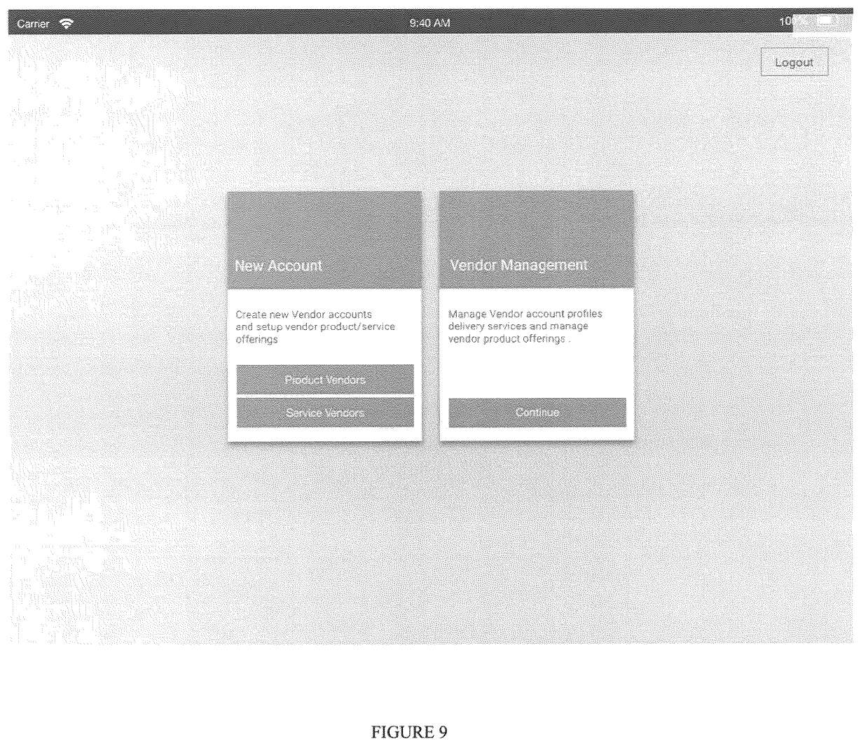

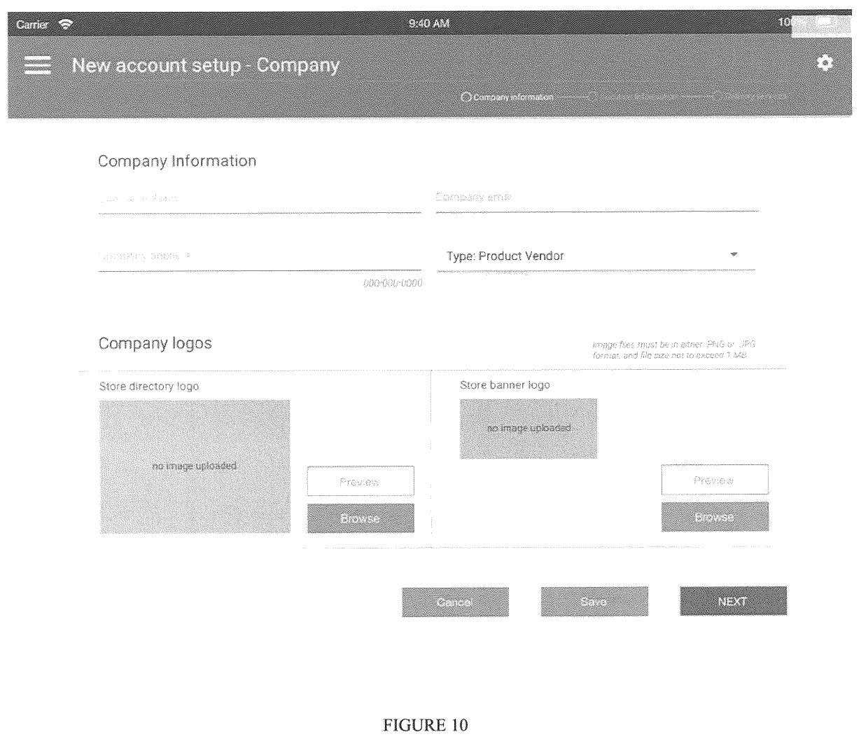

In some embodiments, the system and method may be configured to remove goods and/or service providers that have an average ranking or rating below a set point. This removal of service providers or product/service offerings can be triggered automatically by a pre-defined algorithm or completed manually by an administrator. The administrator can remove the unsatisfactory service provider and/or offerings in its administrator log page, as illustrated by FIG. 8. Furthermore, as illustrated by FIGS. 9 and 10, the administrator can create new vendor accounts and set up its product or service offerings.

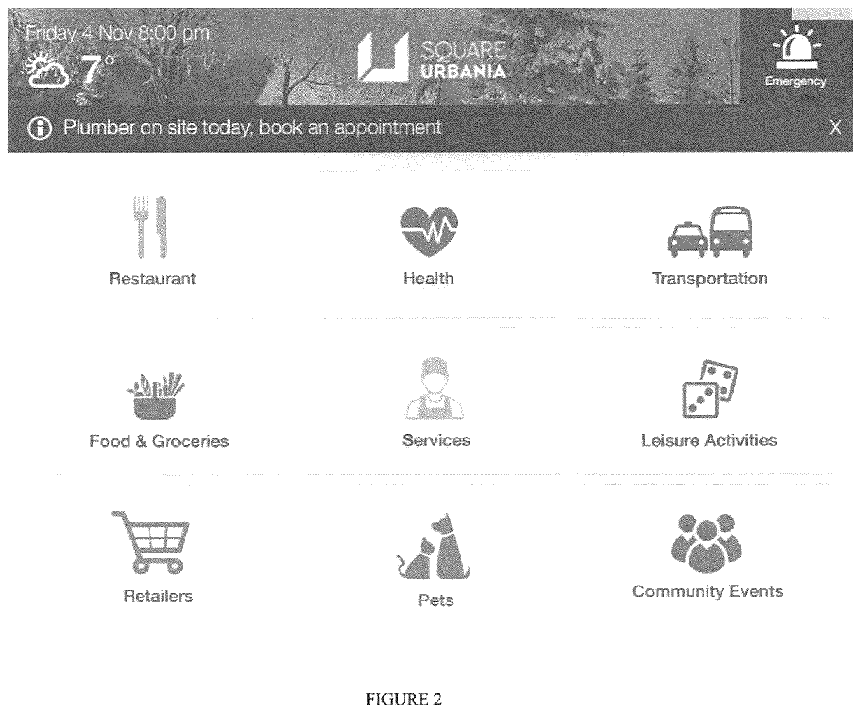

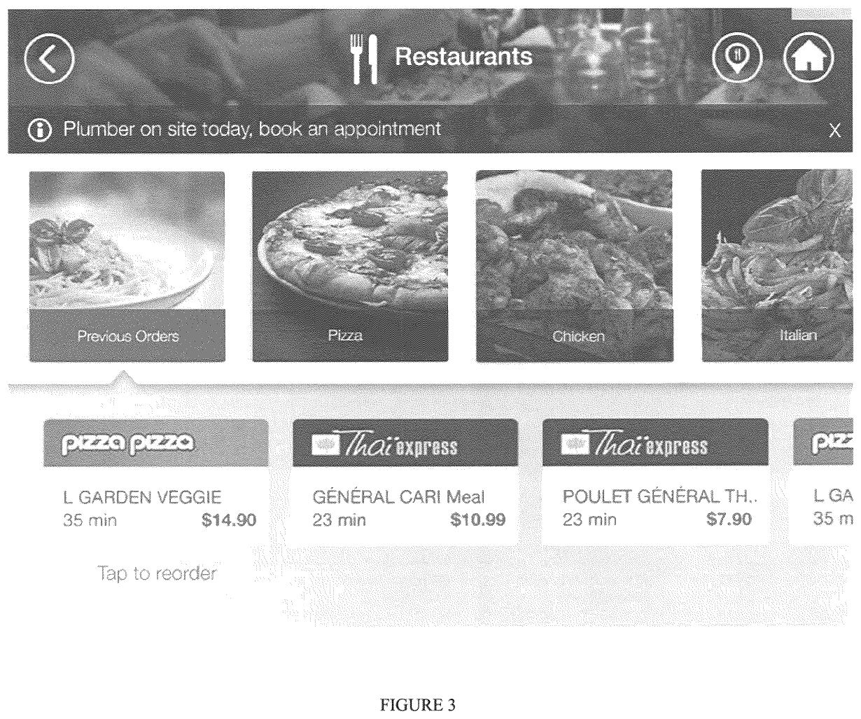

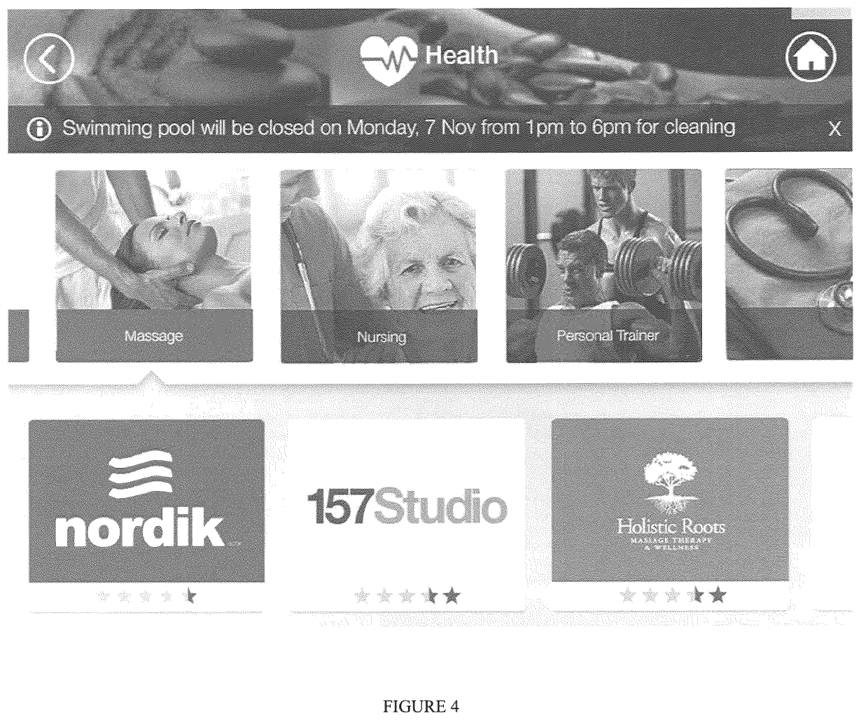

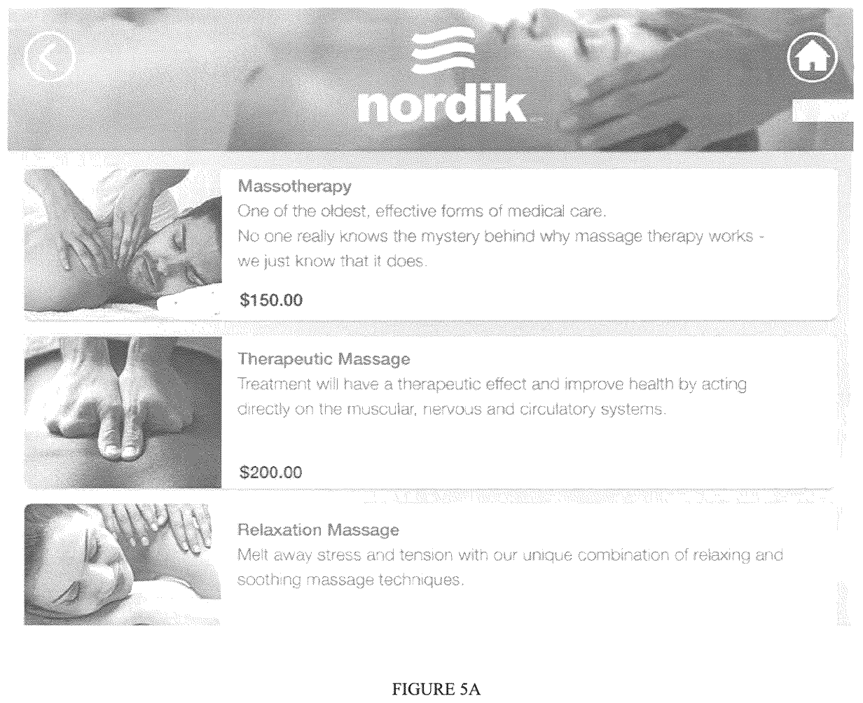

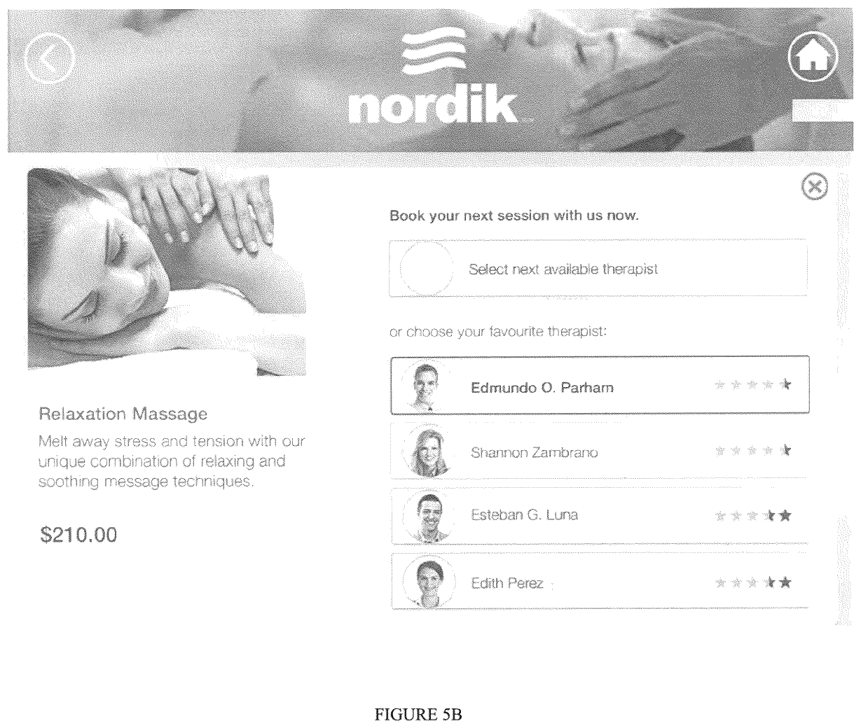

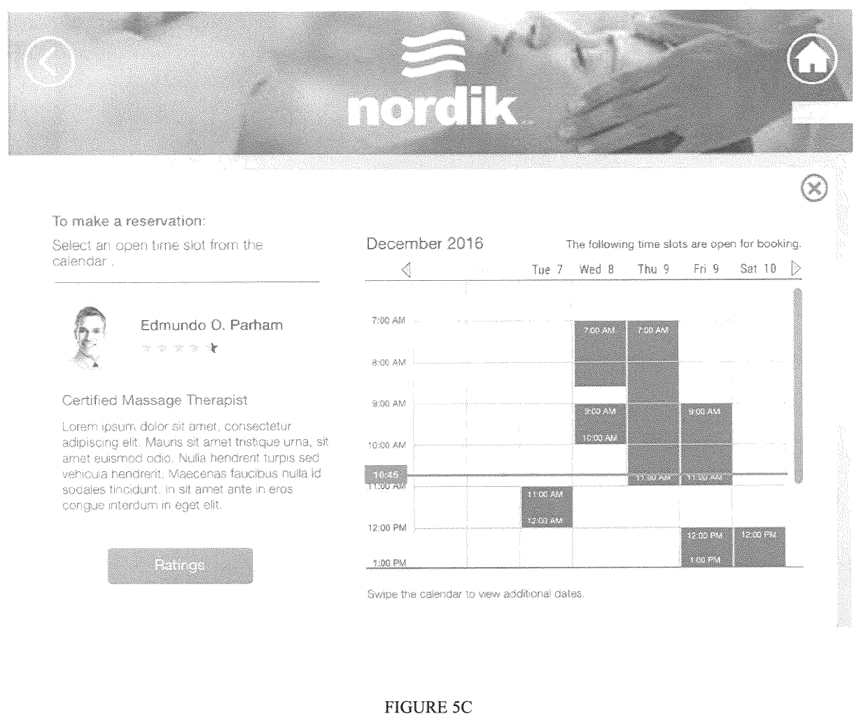

In one embodiment, the interface includes a home page or screen having a menu of options. For example, as illustrated in FIGS. 2, 3, 4 and 5A to 5C, the menu includes a set of selectable icons with each icon representing a class or category of available at home services, products or activities including, for example, restaurant, health, transportation, food and groceries, services, leisure activities, retailers, pet services including animal grooming, veterinary services, dog walking and pet sitting, more, and emergency. In some embodiments, the concierge services can include services that require pick up, including car services, dry cleaning or laundry services, etc.

Once a class or category is selected a class or category home page opens and a page showing subclass or subcategories opens. Selection of a subclass or subcategory opens a page with vendor options.

Once a vendor is selected available products and services are listed.

Optionally, once a product or service is selected a new page opens that allows for modification of the product and/or scheduling of service or delivery.

In some embodiments, the system is configured for operation with third party applications or programs. For example, the system is configured to allow for the uploading of grocery lists, calendar or scheduling programs etc.

The system and method optionally provides for consumer feedback which can optionally be used to adjust vendor ranking.

In some embodiments, the consumer fills an easy survey that is used to rank the vendors. Optionally, the service and product providers are listed based on ranking. In some embodiments, ranking is adjusted regularly, at fixed intervals or in real time.

In some embodiments, the concierge platform adjusts to consumer's preferences and historical use and purchasing habits by presenting the highest ranked providers but also the most used based on usage. Optionally, it also adjusts based on persona, community and city's endorsement of the providers.

The present invention provides a home concierge service for products and/or services. Users of the concierge service access the service via an interface configured to allow the user to search, select, and order products and/or services from designated providers. The system monitors and optionally manages the orders for the products and/or services including monitoring order completion.

The home concierge service user interface is also configured to allow users to track delivery and service personnel.

In some embodiments, the home concierge service includes an at-home concierge application, an optional mobile concierge application, vendor applications including product and service applications, delivery application, platform administration and optional delivery service administration.

The concierge applications including the at-home and mobile application are configured to allow users to purchase products and services and track delivery of products and service personnel by interfacing with the delivery application.

The vendor applications including product and service applications that allow for the creation and/or updating of online menus or stores, receive and confirm orders and view all transactions. The service applications also provide for appointment scheduling or bookings. The system optionally includes service provider or delivery application modules that shows delivery information, provides directions, provides for tracking and optionally provides for an emergency button.

In some embodiments, the tracking provided by the vendor application is specifically configured to allow the system to track the delivery or service personnel and alert if the delivery or service is exceeding a pre-specified period of time. For example, a massage therapist may access the application and activate a timer for a 90 minute appointment. If the timer is not deactivated after 90 minute+specified window of time an alert is sent to the massage therapist and a designated contact indicating that the massage therapist is overdue. Optionally, the alert to the designated contact includes current location and time at location. This feature is intended to provide delivery and service personnel increased personal security.

The home concierge service is operatively associated with a database that stores information about the products and/or service providers. The database also includes details regarding user selections. Details regarding user selections can be used to update product and service selections. A server computing device may comprise one or more operation modules. An operating module or operation module comprising a processor or microprocessor operatively coupled to memory performs one or more operations involving the products and/or service providers, and the user selections and interactions with the system. Some of the operations performed by the operating/operation module include monitoring the system interactions, analyzing selections made by the user, ranking the products and/or service providers, requesting products and/or services, confirming selections and distribution, managing the provision of products and/or services, uploading, downloading, and transferring information or payment.

The present invention also provides a method in which a consumer makes a selection related to products and/or services. The vendor after receiving notice of the order provides the selected product and/or service. The operating/operation module coordinates the provision of product and/or services to the consumer. The operating/operation module facilitates and confirms payment from the user to the products and/or service provider. The operating/operation module then confirms the order has been submitted and accepted by the vendor. The operating/operation module then provides selection tracking capabilities so that the consumer may track their product and/or service selection. Finally, the operating/operation module will notify the consumer that the product and/or service has arrived for consumption or use.

The operating/operation module also ranks the vendor based on the provision of products and/or services to the consumer. This ranking may influence the selection of products and/or services by displaying the products and/or service providers upon the user interface in a manner reflective of the ranking.

In some embodiments, the system and method may require the consumer to provide a ranking of or rate the goods and/or services upon receipt of the same. Optionally, the system and method may prevent further selections of goods and/or services until prior goods and/or services are ranked or rated.

In some embodiments, the consumer is provided a reward for completing a ranking or rating. Rewards may be points redeemable for additional goods and/or services.

Optionally, the ranking may be in the form of a star rating or letter grade. In some embodiments, the system is configured to provide an average ranking or rating based on consumer feedback. The ranking or rating is optionally multi-component and can include factors such as timeliness, goods and/or services quality, etc.

The operating/operation module may also distribute payment for the goods and/or service to a number of entities such as but not limited to the vendor, and/or distributor.

In one embodiment, the vendors may be an individual, group, group of individuals, business, partnership, corporation or other entity able to provide a good and/or service to a user at the user residential dwelling.

In another embodiment, the vendors may provide a goods and/or service to a user at a location as determined by the user.

### System

In one embodiment, the user interface may be accessed within a residential dwelling. The user interface may be available on a touch screen mounted upon the wall of the residential dwelling. The touch screen may be removable. There may be more than one touch screen available within the residential dwelling.

In another embodiment, the user interface may be available online, accessed by using a personal communication device.

In one embodiment, the operating/operation module will use and assess information stored within a database to objectively rank vendors. This ranking will influence the appearance of the vendor upon the user interface.

In another embodiment, the assessment of operating/operation module will result in the display of the three highest ranked vendors upon the user interface. The user will be able to rely on the quality of goods and/or service provided by the vendor based on the display of the vendor upon the user interface. The vendors may be able to improve their ranking by objectively improving the quality of the goods and/or services offered. As the vendor ranking improves, they may overtake other vendors, which may allow them to be displayed upon the user interface. In this way the overall quality of goods and/or services offered to a user will continually improve.

In one embodiment, the operating/operation module may request, confirm, distribute, and manage the provision of goods and/or services by facilitating communication and interaction between a user and a vendor. This communication and interaction may be facilitated through the touch screens as provided within a residential dwelling, and distributed to a vendor. The communication may also be facilitated through personal communication devices of the user and vendor.

In one embodiment, the transfer of payment between the user and the vendor may incur a transaction fee imposed as a lump sum, percentage of sale, or otherwise as would be understood by someone skilled in the art.

In one embodiment, payment may consist of the distribution of money, credits, funds, tokens, barter vouchers, or otherwise as would be understood by someone skilled in the art.

In one embodiment, a portion of the payment for goods and/or services may be redistributed.

In another embodiment, the redistribution of payment may result in the user receiving payment at a later time for having used the consumer goods and/or services distribution system. This redistribution payment may be provided by the vendor, another user, or the distributor.

In another embodiment, the redistribution payment received to a user by a vendor may be as a direct result of the user requesting goods and/or services from that vendor. The vendor may allocate funds previously delegated for another purpose to make up this distribution payment. For example, a vendor may reassign some funding previously allocated to advertising or marketing their goods and/or services. This advertising or marketing funding may then be passed onto a user who selects their goods and/or service as user incentive. This may improve the ability for a vendor to gain new customers. It may also improve the ability of the vendor to monitor the effectiveness of the funds allocated from advertising or marketing budgets.

### Method

In one embodiment, the goods and/or service selection made by a user may be limited to the top three ranked vendors provided upon the user interface.

In another embodiment, a user selecting goods and/or service may have the option to search and select vendors not ranked within the top three upon the user interface.

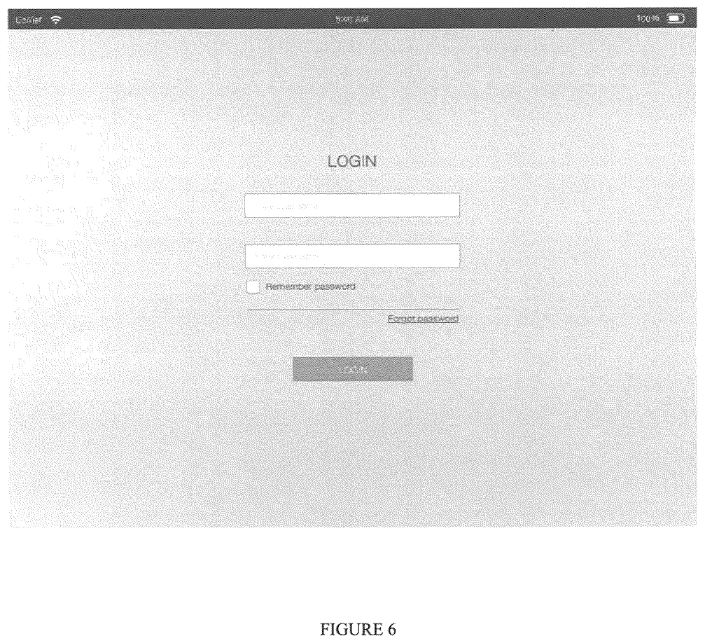

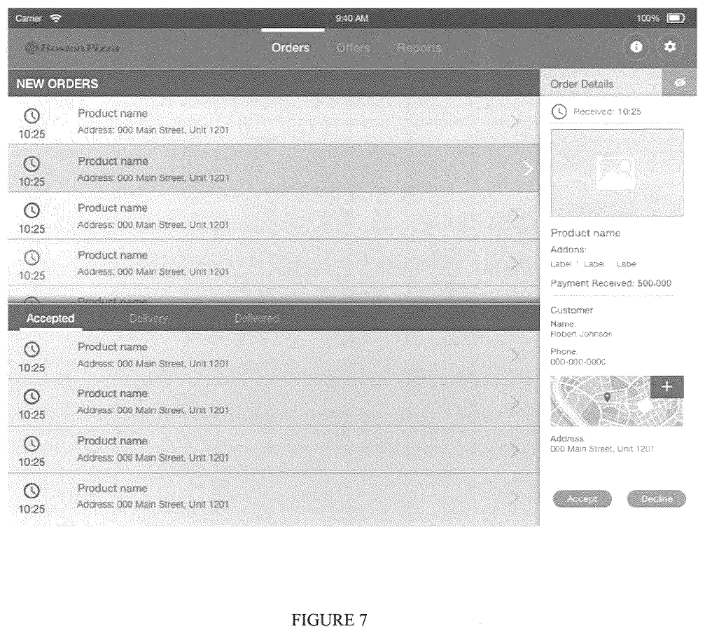

In one embodiment, the vendor will receive a user request, and may choose to fulfill or deny that request. As illustrated in FIGS. 6 and 7, a vendor can log in the system and view the orders or requests and their status (e.g., received, accepted, delivery-in-progress, and delivered/completed).

In another embodiment, the vendor may elect to allow employees of the vendor to make a determination about if they would like to fulfill or deny a user request. The vendor may allow the employee to fulfill a user request in a capacity other than of an employee of the vendor.

In another embodiment, if the selected vendor chooses to deny or refuse a user request, alternative vendors or service providers which are available or capable of completing the request for service will be suggested or communicated to the user.

In one embodiment, the vendor will not provide a goods and/or service until payment has been confirmed received from a user. This confirmation may be provided by the distributor or by the vendor themselves.

In one embodiment, the operating/operation module will provide real-time communication of the progression of steps within the method to a user, vendor, distributor, or other entity as would be understood by someone skilled in the art, in order for these parties to be aware of the progression of the provision of goods and/or services. The parties may provide instruction, directions, or other communication to the operating/operation module through the user interface, in order to better enable the facilitation of goods and/or services from the vendor to the user.

In one embodiment, the user may be able to track the progress of the delivery of a goods and/or service upon the user interface.

In one embodiment, the operating/operation module will provide notifications to a user, through the user interface, related to the arrival of goods and/or service at the location of the user.

Furthermore, the operating/operation module will allow an administrator to manage the list of registered service providers. For example, as illustrated by FIGS. 8 and 9, new vendor accounts can be created and set-up for its product or service offerings. The administrator can manage vendor account profiles, their offerings etc.

The invention will now be described with reference to specific examples. It will be understood that the following examples are intended to describe embodiments of the invention and are not intended to limit the invention in any way.

### Example

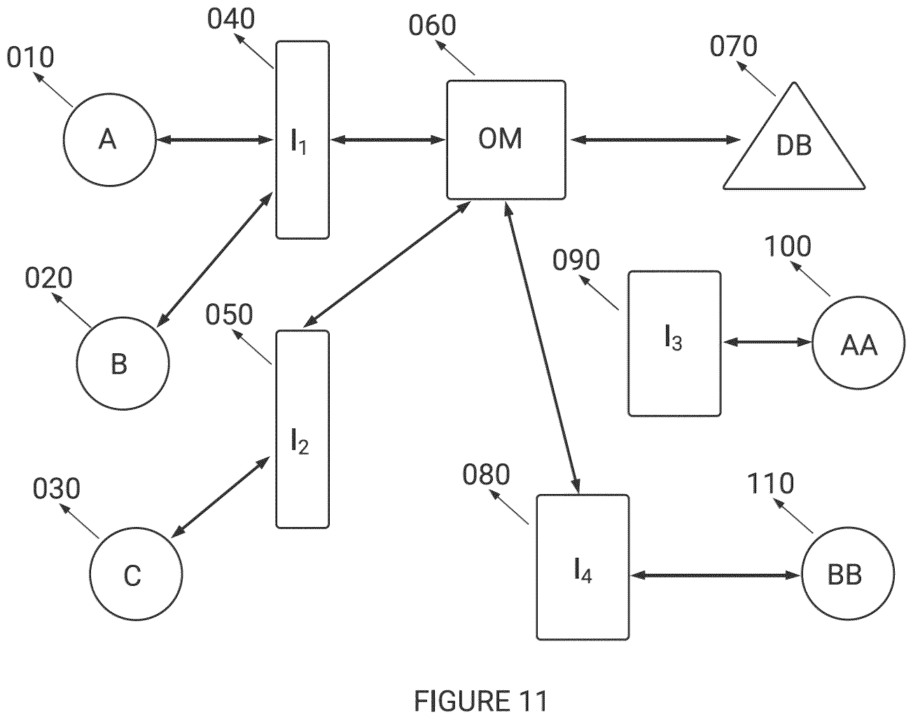

In one embodiment, and as illustrated in FIG. 11, a user A 010 will make a request through user interface 11 040 to obtain a good from vendor BB 110. The interface 11 will interact with the operating/operation module OM 060 in order to facilitate the request from user A. The operating/operation module OM will then send a request through user interface 14 080 to vendor BB. This request will be viewed by vendor BB on the user interface 14, and vendor BB decides to accept the request from user A. A vendor BB acceptance notification may be sent through the user interface 14, and the operating/operation module OM, to appear on the user A's interface 11. The user A will send back payment through the interface 11, operating/operation module OM, and user interface 14 to the vendor BB. Once the operating/operation module OP has confirmed transfer of payment from user A, the vendor BB begins the process of providing the good to user A. User A is able to track to progression of the provision of the good from vendor BB through the user interface 14. Information related to parts or the entirety of the transaction between user A and vendor BB will be stored within database DB 070. A user B 020 from the same family, may also access the consumer goods and/or services distribution system through the same user interface 11. User C 030 will also make a request for services from vendor AA 100. The request will be transmitted through the user interface 12 050, onto the operating/operation module OM, the user interface 13 090, until it finally reaches vendor AA. The vendor AA may deny the request of user C through user interface 13 and the operating/operation module OM, to notify user C on interface 12. Information related to parts or the entirety of the transaction between user C and vendor AA will be stored within database DB. The operating/operation module OM may then analyze the information stored within database DB in order to objectively rank the vendors AA and BB, in order to determine if they will appear on the user interfaces 11 or 12.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, such as C++, Java, PL/1, .Net, Javascript, Go, Python, Perl Web and Cloud Technologies, or the like. In addition, each step, or a file or object or the like implementing each said step, may be executed by special purpose hardware or a circuit module designed for that purpose.

In accordance with embodiments of the present invention, a service provider or vendor is instructed to deliver a goods and/or service to a consumer/user at a location as determined by the consumer or user (e.g., the service location). This service location can be an apartment or unit that the consumer or user resides in, a space that is owned, leased or managed by the user (e.g., the user's locker box in a locker room, a parking spot in the basement), a sharable or public space in the building as determined by the user (e.g., lobby, an amenity room, or a multi-purpose space), or even a space outside the building (e.g., parking lot). The service location can be within or proximal to the physical community or neighborhood. Instead of having a room designated for each function or purpose, this service location is flexible to cater to the various needs of the residents, users, or service providers.

In embodiments, the service location can be reserved by the consumer or user. In embodiments, the consumer or user can be a resident in the building or the community, or anyone using the system's user interface or mobile app. For example, this service location can be served by the service provider or vendor requested to provide a service, or a non-resident user who requests to receive a service in the building. For example, a manicurist registered with the building may reserve the amenity room to provide manicure services to the consumers (e.g., residents or non-residents) at a specified date and time. Furthermore, a manicurist or a team of manicurists registered with the system may reserve available amenity rooms in multiple buildings in a predetermined community setting to advertise or promote manicure services within that geographic range. In another example, a consumer or user may find that the amenity room in their building or a nearby building has been fully booked, and may be presented with options to book another amenity room at a more distant service location.

In embodiments, the amenity room can be reserved for a specific purpose based on the service to be provided (e.g., hair stylist, yoga instructor, massage, food delivery, manicure, basic healthcare checkup, etc.). For security reasons, the service providers or vendors may need to be registered with the building/community or the system to be able to access the user interface or mobile application.

For example, a consumer user may select a manicure service at a specific time by a specific manicurist from the list of top ranked available manicurists, and then continue to reserve an available amenity room at that time in the building; alternatively, a consumer user can select an available amenity room at a specific time in the building, and then choose an available service provider (e.g., an available manicurist or an available massage therapist). The selections or reservations can be performed through any appropriate user interface or mobile application.

A notification or status of the request booking, reservation, and real-time location tracking can be made available to the consumer, the service provider/vendor, or both. In embodiments, the concierge services include a two-way interactive chat or video function between the service provider and the consumer user, or a three-way chat or video function among the service provider, the consumer user, and the building or system management staff.

Subsequently, the service provider is provided with a code to enter the building and further to enter the amenity room/flexible space (with the same code or another code) on their own. In embodiments, different codes may be given for different levels of access, for example, access to garage, access to locker room and further locker box, access to elevator, access to a specific floor, access to a specific room (e.g., the amenity room, the resident's apartment). In another embodiment, one code may be sufficient for all-the-way auto-access to the destination location or service location. The codes may be valid for a reserved time window or time frame (optionally, plus a reasonable buffer time). For example, if the reserved time window or time frame for that amenity room is from 2:00 PM to 3:00 PM for a massage therapist, the massage therapist will need to request a new valid code if he or she arrives later than 3:15 PM. Other service providers or other residents/non-resident users can reserve the same amenity space on days or periods that have not been reserved or in use yet.

In embodiments, the one or more codes can be in different formats. A code can a Quick Response (QR) code, a token, an alphanumeric code, a one-dimensional barcode, a two-dimensional barcode, a data matrix code, an image, a specialized augmented postal code, an intelligent mail code, or an electronic product code.

In embodiments, a code can be generated upon detecting, such as through real time GPS tracking or geofencing, that the service provider is approaching the community or neighborhood, or the destination (e.g., the service location). In embodiments, the code can be generated after the service request is confirmed or payment is made.

In embodiments, authentication of the code can cause one or more doors or gates to open. In embodiments, allowing access or denying access can trigger a notification to be sent to the service provider, the user, and/or the management staff. For example, the notification is dispatched to a device (e.g., mobile phone) of the service provider.

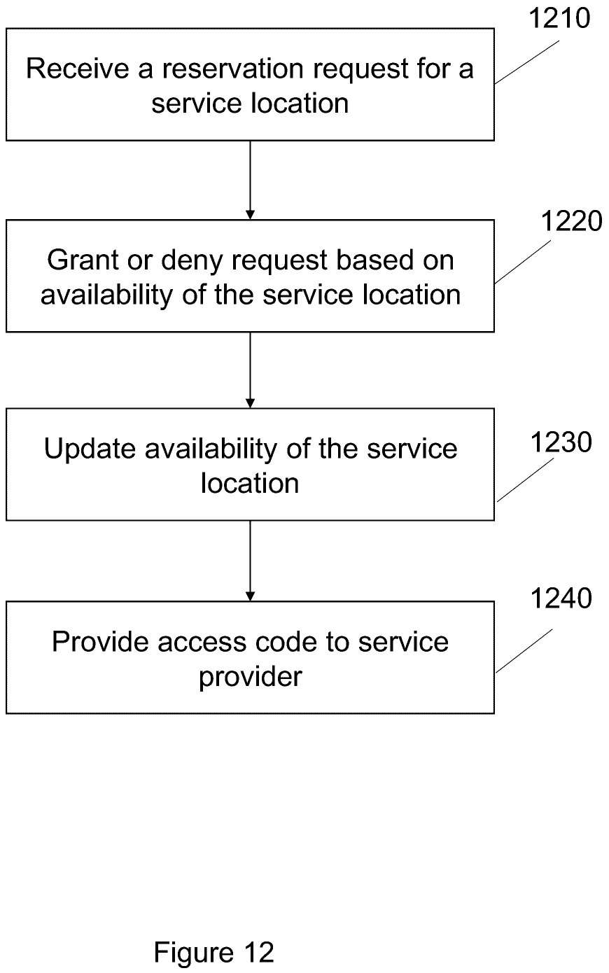

FIG. 12 illustrates a flow diagram of reservation process for a service location, in accordance with an embodiment.

As illustrated, at step 1210, the system (via its server computing device or its operation module) receives a reservation request to reserve or book a service location (e.g., an amenity room in a building) for a time frame or time window.

At step 1220, the system checks the availability of the service location at that requested time frame, and determines whether to grant or deny the reservation request.

At step 1230, if the service location is reserved for that time frame, its availability is updated and displayed on user interfaces. A next person who wants to reserve the service location or view its availability will see that the service location has been reserved for that time frame and can only request to reserve other available time frames at the service location.

At step 1240, the system provides the service provider with one or more codes which allow the service provider to access the service location.

In embodiments, the access code becomes invalid after the expiry of the time frame, the service provider or the user may request a new code (not shown in FIG. 12). In embodiments, a new access code is automatically generated after expiry of the initially requested time frame.

In embodiments, the service provider can be a real estate agent. The real estate agent can request a house viewing or an apartment viewing for a specific time frame in the request. If approved, the real estate agent receives one or more temporary access codes to access the specific house/building, floor, garage/parking, locker, elevator, apartment unit, if applicable.

In embodiments, the user can be a short-term rental tenant. The tenant can access the short-term rental property for the specific rental period and access is automatically denied at the end of lease to prevent a holdover tenant.

In another aspect of the present invention, the user interface may be integrated into smart home devices, allowing users to interact with the system using voice commands. The system may also provide feedback audibly, ensuring a hands-free experience for the user.

In another embodiment, the user interface may be available as a mobile application, allowing users to access the system while on the go. This mobile application may also utilize geolocation features to recommend vendors based on the user's current location.

In one embodiment, the operating/operation module may utilize machine learning algorithms to predict user preferences based on their past interactions and purchases. This predictive analysis can enhance the user experience by presenting tailored vendor recommendations. For example, a consumer user prefers to have decaf coffee on weekends, so wherever the consumer user orders a coffee on weekends, the smart menu will filter and rank the coffee stores providing decaf coffee as preferred vendors on the top of the available list, and when the consumer user tries to order coffee on weekdays, it will not perform this filter operation. In another example, the user interface will remember that the consumer user is gluten intolerant and will automatically filter out dishes that contain gluten and highlight to the user the choices of gluten free products, without further manual instruction from the user.

In another embodiment, the system may offer a loyalty program where users earn points for every transaction made. These points can be redeemed for discounts or special offers from vendors.

In one embodiment, the system may facilitate group orders, allowing multiple users to combine their requests and benefit from bulk order discounts or special deals.

In another embodiment, the system may offer a feature where consumers or users can set up recurring orders, ensuring that they receive specific goods or services at regular intervals without needing to place a new order each time.

Furthermore, in another aspect of the present invention, consumers or users may be able to set preferences for eco-friendly or sustainable vendors, ensuring that their choices align with their personal values.

In another embodiment, the system may offer a “surprise me” feature, where users receive goods or services from top-ranked vendors based on their preferences but without knowing the exact vendor until the delivery.

In one embodiment, vendors may offer time-limited flash deals, which users can access through the user interface. These deals may be based on inventory management needs or promotional events.

In another embodiment, the system may facilitate a bidding process where vendors can offer competitive prices for a user's request, ensuring that the user gets the best possible deal.

### Example 2

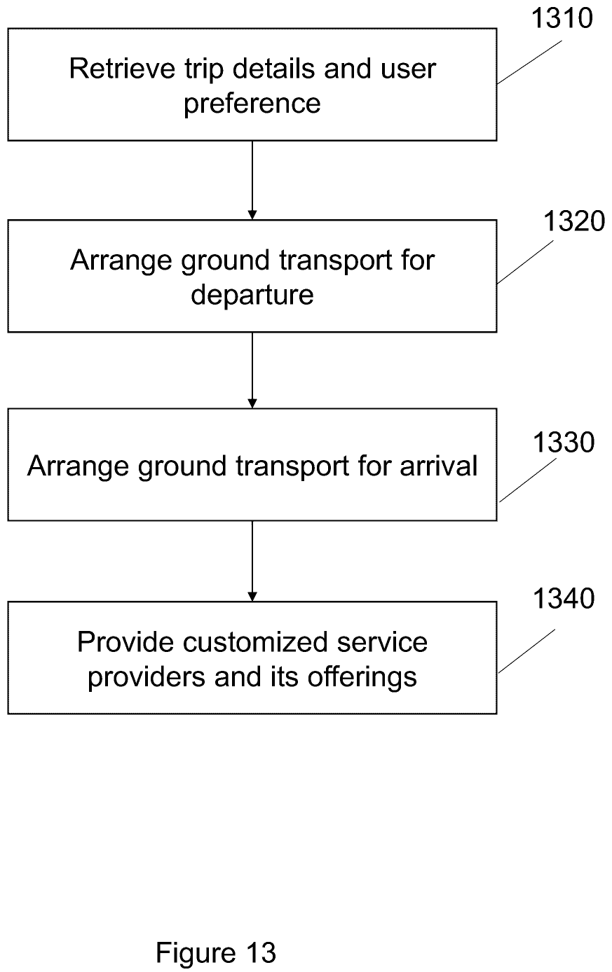

FIG. 13 illustrates a flow chart of how a non-resident user plans their trip using the system, according to an embodiment. In relation to the present disclosure, the term “non-resident” refers to a person who does not reside permanently or for an extended period (e.g., the lease period of an apartment unit) in a usual dwelling (e.g., a condominium building). A person who temporarily stays at a place (e.g., an Airbnb place, a hotel building) is considered as a “non-resident”. A person may be a resident user in one city, and switched to be a non-resident user in another city, depending on how the system manages its user profiles.

For example, a consumer user F, residing in Toronto, plans a trip to New York. As part of his travel planning, he accesses the system's user interface or mobile application via his smart phone device to streamline his journey from Toronto to New York.

Starting with his departure from Toronto, at step 1310, user F's flight details and preferences are provided to or retrieved by the system for further analysis. At step 1320, the system (via the server computing device or the operation module) arranges ground transport based on the information analyzed. For example, a taxi or Uber trip may be pre-arranged to pick him up from his residence or departure location. Based on other information (e.g., real-time traffic flow or jam, local weather), the system calculates an estimated pick-up time, to allow user F to reach the airport with ample time for check-in and security checks. Before the scheduled pick-up, user F receives a notification, reminding him of the impending arrival of his transportation.

At step 1330, the system plans or arranges transportation for user F so that user F will receive a notification before or upon landing in New York. For example, a car rental service, chosen based on user F's past preferences and the system's vendor rankings, awaits him outside the airport. The car is equipped with pre-entered routing directions to his destination (e.g., a hotel building). In another example, if user F prefers public transportation (e.g., bus, tram, subway, and train), the system provides timely updates for public transportation schedules, routes, etc.

Simultaneously, with his health and relaxation in mind, user F had expressed interest in booking a blood pressure check-up or massage appointment in New York. At step 1340, the system recommends service providers based on user F's preferences, vendor rankings and availability, and proximity to his accommodation. The suggested providers are either within the same hotel building where user F has booked his stay or at a nearby location.

Upon confirming his selection, the system proceeds to generate and provide access code either to the service provider or the consumer user. If user F's accommodation is in the same building as the service provider, he may receive a digital key on his phone, granting him access to both his short-term rental unit (e.g., hotel room) and the service provider's facility without the need for a physical check-in at the receptionist. Alternatively, if user F prefers, the system provides the service provider with a temporary access code, so that user F can enjoy the service without leaving his unit. In another example, user F may choose to reserve an amenity room in the hotel building for completion of the requested service, so he does not need to leave the hotel building and still maintain some extent of privacy in his hotel room.

Throughout this journey, the system maintains real-time communication with user F, updating him on his bookings, access codes, and other pertinent details, ensuring a hassle-free and personalized travel experience from Toronto to New York.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

The scope of the claims should not be limited by the preferred embodiments set forth in the examples but should be given the broadest interpretation consistent with the description as a whole.

What is claimed is:

1. A real-time computer implemented method of an in-residence e-commerce service for a physical community or neighborhood, the method comprising:
receiving, from a user interface operated by a user, by a server computing device comprising an operation module including a processor, a request for service at a flexible service location within or proximal to the physical community or neighborhood, the request including a time frame;
providing, by the operation module, in accordance with the request, ranked providers for the service located within or proximal to the physical community or neighborhood capable of completing the request;
displaying, on the user interface, for selection by the user, the ranked providers;
receiving, by the operation module, from the user interface, a selected ranked provider from the ranked providers to complete the request;
enabling, by the operation module, completion of the request by the selected ranked provider, the completion of the request comprising:
requesting, by the operation module, a reservation for the service location from the selected ranked provider or the user;
granting the reservation based on an availability of the service location; and
updating by the operation module and displaying on the user interface an updated availability of the service location; and
the method further comprising, by a home management system of the service location, interacting with the selected ranked provider and the server computing device and allowing access to the service location of the user for the selected provider, to facilitate completion of the request, wherein the access to the service location is allowed by providing an access code valid for the time frame to the selected ranked provider.

2. The method of claim 1 further comprising providing a new access code when the access code is invalid after expiry of the time frame.

3. The method of claim 1, further comprising storing information relating to the completed request within a database.

4. The method of claim 3, further comprising analyzing the information related to the completed request for use in further ranking the selected ranked provider.

5. The method of claim 3, wherein the database further comprises information regarding past user selections.

6. The method of claim 1, wherein the access is overridable.

7. The method of claim 1, wherein geolocate IP address and geospatial data are utilized to provide access to the service location for the selected ranked provider.

8. The method of claim 1, wherein the server computing device is cloud based.

9. The method of claim 1 further comprising:
communicating alternative providers capable of completing the request for service in response to receiving a response indicative of a refusal to the request for service from the selected ranked provider.

10. The method of claim 1, wherein the service includes a service of delivery of a product.

11. A system comprising a server computing device and a home management system, the server computing device being in communication with one or more user devices via a network and being configured to interact with the home management system, the server computing device comprising an operation module including a processor and a computer program product storing instructions that when executed by the processor, cause the server computing device to:
receive, from a user interface on a user device of the one or more user devices, a request for service at a service location within or proximal to the physical community or neighborhood, the request including a time frame;
provide, via the operation module, ranked providers for the service, the ranked providers located within or proximal to the physical community or neighborhood and capable of completing the request;
display, for selection by the user, the ranked provided on the user interface;
receive, by the operation module, from the user interface, a selected provider from the ranked providers to complete the request; and
cause the home management system to interact with the selected ranked provider and the server computing device to allow access to the service location for the selected provider, to facilitate completion of the request, the access being based on an access code valid for the time frame provided to the selected ranked provider; and
wherein the instructions further cause the server computing device to:
request, by the operation module, a reservation for the service location from the selected ranked provider or the user;
grant the reservation based on an availability of the service location; and
update by the operation module and display on the user interface an updated availability of the service location.

12. The system of claim 11, wherein a new access code is provided when the access code is invalid after expiry of the time frame.

13. The system of claim 11, wherein the instructions further cause the server computing device to store information relating to the completed request within a database.

14. The system of claim 13, wherein the instructions further cause the server computing device to analyze the information related to the completed request for use in further ranking the selected ranked provider.

15. The system of claim 13, wherein the database further comprises information regarding past user selections.

16. The system of claim 11, wherein the access is overridable.

17. The system of claim 11, wherein geolocate IP address and geospatial data are utilized to provide access to the service location for the selected ranked provider.

18. The system of claim 11, wherein the server computing device is cloud based.

19. The system of claim 11, wherein the instructions further cause the server computing device to communicate alternative providers capable of completing the request for service in response to receiving a response indicative of a refusal to the request for service from the selected ranked provider.

20. The system of claim 11, wherein the service includes a service of delivery of a product.
